(19) United States
(12) Patent Application Publication
(10) Pub. No.: US 2026/0254186 A1
(43) Pub. Date: Aug. 27, 2026

(54) AN OPTICAL SYSTEM COMPRISING A NANOCAVITY

(71) Applicant: DANMARKS TEKNISKE UNIVERSITET, Kongens Lyngby (DK)

(72) Inventors: Yi YU, Kongens Lyngby (DK); Jesper MORK, Kongens Lyngby (DK)

(21) Appl. No.: 19/162,858

(22) PCT Filed: Mar. 6, 2024
(86) PCT No.: PCT/EP2024/055914

§ 371 Date: Sep. 5, 2025

(30) Foreign Application Priority Data
Mar. 6, 2023 (EP) 23160170.9

(51) Int. Cl. H01S 3/06; B82Y 20/00; H01S 3/08

(52) U.S. Cl. CPC H01S 3/0627; B82Y 20/00; H01S 3/08

(57) ABSTRACT

An optical system includes a nanocavity having at least one nanostructure shaped to provide sub-wavelength confinement of an electromagnetic optical field. The nanocavity is shaped and formed to host a bound state in the continuum to provide spatial concentration and temporal storage of the electromagnetic optical field at the at least one nanostructure via an eigenmode of the electromagnetic optical field in the nanocavity. A method is for processing an electromagnetic optical field.

### FIELD OF THE INVENTION

The present invention relates to an optical system comprising a nanocavity and a method for processing an electromagnetic optical field.

### BACKGROUND OF THE INVENTION

Optoelectronics relates to the application of devices and systems that emit, detect, modulate, and control photons and electrons, for example, based on the quantum mechanical effects of light on materials.

A fundamental barrier that restricts the integration of optoelectronics with electronic integrated circuits is the size of conventional optoelectronic devices, which are simply orders of magnitude larger than today's standard components used in modern electronic integrated circuits.

The prospect of developing optoelectronic devices which can be integrated into modern electronic integrated circuits can potentially pave the way for improved communication speed, signal quality, photonic computing, and lower energy consumption.

The publication [Gafsi, Saddam, et al. “Optically resonant all-dielectric diabolo nanodisks.” Appl. Phys. Lett. 120, 261702 (2022)] discloses that subwavelength modifications to a conventional silicon nanodisk enable strong sub-diffractive and polarization dependent field enhancements in devices supporting anapole-like states.

The existing solutions, however, might not support relevant applications. Thus, there is a need for new approaches which may potentially miniaturize optical systems.

### SUMMARY

On the above background, it is an object of preferred embodiments of the invention to provide a miniaturized optical system that can potentially enable the integration of various optoelectronic devices into integrated circuits. In particular, it may be an object of the invention to provide a small optical system that can potentially facilitate improved light-matter interactions. It is a further object of preferred embodiments of the invention to provide improved miniaturized optical systems, which can be utilized as a basis for a nanoscale laser.

A first aspect of the present disclosure relates to an optical system comprising: a nanocavity having at least one nanostructure shaped to provide sub-wavelength confinement of an electromagnetic optical field, the nanocavity being shaped and formed to host a bound state in the continuum to provide spatial concentration and temporal storage of the electromagnetic optical field at the at least one nanostructure via an eigenmode of the electromagnetic optical field in the nanocavity.

The invention provides two key elements. The first one is the sub-wavelength confinement of an electromagnetic optical field provided by a nanostructure in a nanocavity. The second one is the bound state in the continuum formed by the nanocavity by shaping its geometry. The combination of these two elements may establish an improved concentration and storage of electromagnetic optical fields within the realm of ultra-small dimensions, which in turn may enable the construction of unprecedented small optoelectronic devices such as nanoscale lasers and photodetectors large-scale high-density integration of optoelectronic devices with electronic integrated circuits. The strong spatial concentration at a specific area or point and long temporal storage of the whole electromagnetic optical field in a nanocavity can potentially be used to ensure strong light-matter interaction, which can enable efficient optical systems.

An ‘optical system’ is understood as a system for light-matter interactions, such as for providing, storing, conveying and/or re-emitting light in response to a stimulus, such as incident light and/or an applied electrical signal.

A nanocavity may also be referred to as a nanoparticle and typically has dimensions on the order of a few micrometers or below. For example, the largest dimension can be at most 10 micrometers, for example, at most 8 micrometers, for example, at most 6 micrometers, for example 5 micrometers, for example 4 micrometers, such as 2 micrometers. An example of a nanocavity is a Mie-type resonator. Conventionally, such nanocavities were not considered promising candidates for confining electromagnetic optical fields since the inherent optical eigenmodes are leaky, i.e., they tend to emit radiation into the continuum.

However, according to preferred embodiments of the invention, the nanocavity is shaped and formed to host a bound state in the continuum (BIC).

Within the scope of the present invention, a BIC is considered to have the following properties. Firstly, the energy of the BIC lies in the continuous spectrum of propagating modes of space (i.e., the continuum) surrounding the nanocavity. Secondly, the BIC interacts weakly with any of the states or modes of this continuous spectrum. That is, it tends not to be excited by or emit into states of the continuum. Thirdly, the quality factor (Q factor) associated with BIC in the nanocavity is large, such as several thousands. According to these criteria, a BIC may also be referred to as a quasi-bound state in the continuum (quasi-BIC) since the Q factor is not infinite and a very weak interaction between the state and the continuum is permitted. It is to be understood that the nanocavity, according to the present invention, can be shaped and formed to host a quasi-BIC, i.e., it is conceivable and encompassed by the present invention that the Q factor is not infinite and that a very weak interaction between the state and the continuum is permitted.

Conventionally, various approaches have been considered for manipulating and controlling light in nanoscale optical systems, for example utilizing anapole-like states which are not eigenmodes. However, in contrast to previous work, preferred embodiments of the present invention rely on an eigenmode. Such an eigenmode is based on a BIC in combination with a nanostructure providing sub-wavelength confinement to obtain spatial concentration and temporal storage of the electromagnetic optical field at the nanostructure. In turn, this enables the nanocavity to be used as a powerful building block in various optical systems. As a prominent example, spatial concentration and temporal storage of an electromagnetic optical field via an eigenmode of the nanocavity enable the nanocavity to be used as a laser. If the electromagnetic optical field was concentrated and stored by other means than an eigenmode of the nanocavity, the nanocavity generally can not be used as a laser.

Note, however, that embodiments of the invention are not limited to optical cavities of lasers. The nanocavity may be used in any optical system, for example, to construct light-emitting diodes (LEDs), modulators, photodetectors, etc. In more general terms, the invention may potentially improve small optoelectronic devices or enable unprecedented small optoelectronic devices.

In the context of the present invention, an eigenmode may be understood as an eigenmode of the electromagnetic optical field in the nanocavity. A nanocavity may typically have many eigenmodes, but preferred embodiments of the invention require one of these eigenmodes to be bound in the continuum. Excitation of this eigenmode corresponds to one or more quanta of energy convertible into a photon frequency f via the Planck constant h, i.e., E=hf. In turn, this frequency is convertible into a wavelength of the electromagnetic optical field in the medium of the nanocavity via the speed of light c via A/n=c/(nf) where n is the refractive index of the medium of the nanocavity. Thereby, an eigenmode inherently defines the wavelength of the electromagnetic optical field in the medium of the nanocavity. This wavelength A/n (of the electromagnetic optical field in the eigenmode and in the medium of the nanocavity) can be used to quantify the geometry of the nanocavity.

According to preferred embodiments, the eigenmode (providing spatial concentration and temporal storage of the electromagnetic optical field) is the BIC.

A viable approach for shaping a nanocavity to host a BIC is to tailor the structure (geometry, height, width, length, shape, materials, etc.) such that two leaky modes destructively interfere. By having two modes of the same spatial symmetry and close or equal eigenfrequencies and having some perturbation that couples these modes, the perturbation can be tuned such that far-field components of the two modes destructively cancel each other, and the resulting eigenmode is a BIC (or quasi-BIC).

In preferred embodiments of the present disclosure, the nanocavity constitutes a non-Hermitian system for photons, and resultingly, the modes can couple with each other. Thereby, the mutual interaction between the modes typically occurs when they are close in frequency. Hence, in practice, the perturbation required to establish a BIC typically arises automatically and can potentially be further enhanced by the optimization of geometric parameters of the nanocavity.

In the following, one way to specify the condition for the establishment of a BIC is formulated based on [Koshelev, Kirill, et al. “Bound states in the continuum in photonics.” arXiv: 2207.01441 (2022)] which is hereby incorporated by reference in its entirety.

Two modes |ψₛ [symbol] , with s=1, 2, having close or equal eigenfrequencies Ωₛ=ωₛ+iγₛ can couple to establish a mixed state |ψ_{BIC} [symbol] =α₁(t)ψ₁ [symbol] +α₂ (t)|ψ₂ [symbol] . The complex amplitudes α=[α₁(t), α₂(t)]^{T} evolve as

$$\frac{da}{dt} = \hat{H} a$$

$$\hat{H} = - i ( \begin{matrix}{ω}_{1} & κ \\ κ & {ω}_{2}\end{matrix} ) - ( \begin{matrix}{γ}_{1} & \sqrt{{γ}_{1} {γ}_{2}} {e}^{i ϕ} \\ \sqrt{{γ}_{1} {γ}_{2}} {e}^{i ϕ} & {γ}_{2}\end{matrix} )$$

where κ is responsible for the internal coupling, \sqrt{γ₁γ₂} accounts for the coupling through the radiation continuum, and φ is the phase shift between the modes. Based on this, a condition for the presence of a BIC can be formulated as

$$κ ( {γ}_{1} - {γ}_{2} ) = {e}^{i ϕ} \sqrt{{γ}_{1} {γ}_{2}} ( {ω}_{1} - {ω}_{2} )$$

with φ=πm, where m is an integer.

Using the above-outlined condition, the geometry of a nanostructure can thereby be shaped and formed to host a BIC.

Both materials, size, and shape of the nanocavity can influence the modes and thereby be adapted to provide the BIC. Thus, the nanocavity is typically required to be both geometrically shaped and formed by adequate materials to host a BIC. In typical approaches, a preferred material is selected to form the nanocavity, such as indium phosphide, and the geometry is then shaped and scaled to provide the BIC. In other approaches, a mixture of materials can be used to form the nanocavity, for example, via domains of different materials.

An example of two modes that can be coupled in embodiments of the invention to establish the BIC is a Fabry-Perot mode and a Mie mode of a cylindrical nanocavity. Here, the Fabry-Perot mode may be understood as a mode oscillating/resonating/propagating between two parallel surfaces, such as a top surface and a bottom surface of a nanocavity having a planar geometrical shape. A Mie mode may be understood as a mode that can be analyzed or approximated by employing a solution of Maxwell's equations to, e.g., an infinite cylinder having a diameter comparable to the wavelength of the eigenmode. Even though an analytical Mie solution to Maxwell's equation is based on geometries such as spheres and infinite cylinders, the results and principles offered by Mie solutions can still be utilized to understand cylinders of finite size or other nanocavities. Another example of two modes that can be coupled in embodiments of the invention to establish the BIC is two Mie modes of two resonator segment plates.

In one example, the (quasi-) BIC can be confirmed by monitoring the Q-factor variations of the two coupled modes versus a geometric parameter. Typically, one can observe that the Q-factor of the target BIC mode (the other mode) reaches the maximum (minimum) at almost the same parameter point, accompanied by a crossing or avoid-crossing of the two modes in wavelength, see [Huang, L., Xu, L., Rahmani, M., Neshev, D. & Miroshnichenko, A. E. Pushing the limit of high-Q mode of a single dielectric nanocavity. Adv. Photonics 3, 1-9 (2021)], which is hereby incorporated by reference in its entirety.

In addition, the BIC can be strictly verified by employing a quasi-normal mode method. The process begins by computing the eigenmodes at a certain geometric parameter value where the eigenmode frequencies are away from the mode anti-crossing/crossing point so the mode interaction is negligible. Then these eigenmode profiles and their complex resonant frequencies serve as a basis for predicting the resonant frequencies and quality factors of the eigenmodes at other geometric parameter values using quasi-normal mode perturbation theory Error! Reference source not found. Using perturbation theory, one can calculate exactly the interaction Hamiltonian Ĥ for the system at each parameter value. The BIC can thus be quantified by examing the off diagonal term of Ĥ, which should be comparable, around the mode crossing/anti-crossing point, to the imaginary parts of the diagonal terms of Ĥ. This signify strong field interference effects and the establishment of the BIC.

Another approach to realize an adequately shaped nanocavity is to utilize numerical optimization while aiming to fulfill the above-outlined condition for the presence of a BIC, for example, by minimizing the difference between the right-hand side and the left-hand side of the equation. Such optimization may, for example, be based on numerically solving the Maxwell equations to provide the eigenfrequencies while iteratively changing the geometry.

In this context, the resonator is nanocavity, or more specifically, the BIC of the resonator. The BIC may be quantified through the Q factor, a dimensionless parameter defined as the ratio of the initial energy stored in a resonator to the energy lost in one radian of the oscillation cycle. A high Q factor indicates a lower rate of energy loss. Preferred embodiments of the invention have a Q factor of at least 1000.

The Q factor may be used as a parameter for optimization of the geometry of a nanostructure, as an alternative, or as an addition to the above-outlined condition for the presence of a BIC. Providing a geometry of a nanocavity with a sufficiently large Q factor will typically be associated with that geometry hosting a BIC. Since a BIC or quasi-BIC will often be inherently associated with a large Q factor, there is no explicit need for specifying that a BIC condition is fulfilled. Nevertheless, the condition for BIC can be used as a suitable initial objective when outlining a nanocavity before optimizing the Q factor.

A theoretical BIC may be considered to have an infinite Q. However, in reality, any eigenmode has a finite decay, e.g., due to material absorption, meaning the Q-factor is also finite. Therefore, only quasi-BIC exists in the real world. A criterion for the presence of a quasi-BIC may also be formulated as R_{Q}=γₑ₂/γₑ₁>20, where γₑ₁ and γₑ₂ are the real parts of the eigensolutions of Ĥ. Here, γₑ₁ and γₑ₂ reflect the decay rates of the quasi-BIC and its interacting (anti-BIC) mode, respectively. So R_{Q} reflects the ratio of their Q factors. In addition, one can also verify the BIC based on the evolution of the Q-factor with respect to the geometric parameters. A BIC is always accomplished by a crossing/anti-crossing of two modes in frequency, i.e., one mode gets the highest Q-factor while the other gets the lowest simultaneously almost at the same parameter point. In other high-Q cases, the evolution of the Q-factors of the modes is rather independent.

In addition to a BIC, preferred embodiments of the invention also rely on having a nanostructure, for example a tapered nanostructure, shaped to provide sub-wavelength confinement. Such sub-wavelength confinement may be established by exploiting electromagnetic boundary conditions between two mediums having different refractive indices, as described in, e.g., [Hu, Shuren, et al. “Experimental realization of deep-subwavelength confinement in dielectric optical resonators.” Science advances 4.8 (2018): eaat2355.], [Choi, Hyeongrak, Mikkel Heuck, and Dirk Englund. “Self-similar nanocavity design with ultrasmall mode volume for single-photon nonlinearities.” Physical review letters 118.22 (2017): 223605.], [Wang, Fengwen, et al. “Maximizing the quality factor to mode volume ratio for ultra-small photonic crystal cavities.” Applied Physics Letters 113.24 (2018): 241101.], and [Albrechtsen, Marcus, et al. “Nanometer-scale photon confinement inside dielectrics.” Nat Commun 13, 6281 (2022)] which are hereby incorporated by reference in its entirety. In particular, across an interface between two different mediums, the tangential component of the electric field and the normal component of the displacement field are continuous. As a consequence thereof, an electromagnetic optical field can be confined inside, e.g., a channel of a high-index medium having an interface with a low-index medium, despite the channel having a transverse width significantly smaller than the wavelength of the electromagnetic optical field.

In practice, one approach providing a nanostructure offering sub-wavelength confinement is to implement index discontinuities along the electric field polarization direction (preferably of the BIC) in the nanocavity, for example, in the center of the nanocavity. Such discontinuities can, for example, provide a slanted channel, having a tapered shape that funnels or guides an optical field into a small volume of the slanted channel.

The effectiveness with which sub-wavelength confinement is provided may be quantified by the mode volume V which may be calculated as

$$V = \frac{\int ε ( x ) {\vert E ( x ) \vert}^{2} d x}{max \{ ε ( x ) {\vert E ( x ) \vert}^{2} \}}$$

where E is the electrical field, x is the coordinate vector, and ε is the permittivity. A small mode volume indicates efficient sub-wavelength confinement.

In embodiments of the present disclosure, the parameter max {ε(x)|E(x)|²} is located within the high-index medium even though max {|E(x)|²} (without permittivity ε) can be located in the low-index medium. Optimization of a nanostructure may optionally involve checking that max {ε(x)|E(x)|²} is located within the high-index medium.

Often, the mode volume is specified in terms of wavelength λ of the electromagnetic optical field relative to the refractive index n of the relevant material. The embodiments disclosed herein have a mode volume of at most 2 in units of (wavelength/n)³, and a preferred value is <1 (wavelength/n)³.

The capability by which an optical system or nanocavity is able to provide spatial concentration and temporal storage of an electromagnetic optical field may be evaluated by taking into account both the Q factor and the mode volume V. Preferably, Q/V should be as large as possible, for example at least 3000 in units of (wavelength/n)⁻³.

The quantity Q/V may also be used as an optimization parameter for optimizing the geometry of a nanocavity. Using this parameter, both the sub-wavelength confinement providing spatial concentration and the BIC providing temporal storage are taken into account in optimization.

Preferred embodiments of the invention thereby combine the concepts of sub-wavelength confinement and BIC to provide improved spatial concentration and temporal storage of the electromagnetic optical field.

An aim of some examples of the invention is to provide a nanocavity which is small in comparison with conventional solutions. In this regard, the invention may be quantified by means of a structural footprint. Such a quantification in terms of a structural footprint may serve as an addition or an alternative to a quantification in terms of a Q factor and/or a quantification in terms of mode volume V.

In the present disclosure, the structural footprint is denoted S and may be defined as a cross-sectional area of the nanocavity parallel to a planar bottom surface and/or parallel to a planar top surface of the nanocavity. Preferably, the structural footprint is quantified relative to a wavelength of the electromagnetic optical field in vacuum. For example, the structural fooprint is smaller than 3 in units of squared wavelength of the electromagnetic optical field in vacuum, i.e., S<3λ².

The capability by which an optical system or nanocavity is able to provide spatial concentration and temporal storage of an electromagnetic optical field without compromising a structural footprint may be evaluated by taking into account both the Q factor, the mode volume, and the structural footprint S. Preferably, this parameter, Q/(VS), should be as large as possible, for example at least 5000 in units of (n³/wavelength⁵), where n is the refractive index of the second medium, and the wavelength is that of the electromagnetic optical field in vacuum.

According to the invention, nanocavities may, for example, have a dumbbell structure. The nanocavity is formed by two resonator segment plates which are connected and/or optically coupled via a nanostructure arranged centrally between these two resonator segment plates. As another example, according to the invention, nanocavities may have a disc-like shape with one or more nanostructures formed by gaps in the nanocavity.

Preferably, the frequency of the electromagnetic optical field lies in a range from 100 THz to 600 THz, for example, in a range from 150 THz to 500 THz, such as in a range from 170 THz to 350 THz.

In examples of the present disclosure, the nanocavity is formed by a first medium having a peripheral interface with a second medium, wherein a refractive index associated with the electromagnetic optical field is greater in the first medium than in the second medium.

Having the nanocavity formed by the first medium with a greater refractive index may provide improved spatial concentration and/or temporal storage of the electromagnetic optical field.

Alternatively, the first medium may be referred to as a high-index medium, and the second medium may be referred to as a low-index medium. Typically, the low-index medium may be atmospheric air, vacuum, or silicon oxide, i.e., a medium with a refractive index of approximately 1. The high-index medium can be any dielectrics, for example, silicon, silicon nitride, silicon carbide, lithium niobate, III-V materials such as indium phosphide (InP), gallium arsenide (GaAs), aluminum gallium arsenide (AlGaAs), indium gallium arsenide (InGaAs), and indium gallium arsenide phosphide (InGaAsP). The high-index medium can also be layered materials such as transition metal dichalcogenides (TMD).

In preferred embodiments, the second medium surrounds the first medium, such as surrounds at least 180°, such as at least 270°, such as 360°, around at least one (fictitious) axis through the first medium. For example, the material of the first medium is shaped to provide the nanocavity itself, which in turn is surrounded by the second medium.

In examples of the present disclosure, the nanocavity has a planar bottom surface and a planar top surface parallel to the bottom surface.

The planar bottom and top surface may provide the nanocavity with a planar geometrical shape.

The provision of nanocavity with parallel bottom and top surfaces may constitute an improved resonating structure out of the nanocavity. Further, such structures can be more straightforward, theoretically optimized, and manufactured in practice.

In examples of the present disclosure, the nanocavity has the same cross-sectional shape in any plane parallel to and between the bottom surface and the top surface.

In examples of the present disclosure, the nanocavity has a cylindrical shape, such as with the shape of the nanocavity being defined by a generatrix and a directrix being a rectilinear path perpendicular to the generatrix, such that a shape of the generatrix corresponds to any of the top surface and the bottom surface.

In examples of the present disclosure, a thickness of the nanocavity perpendicularly to and measured between the bottom surface and the top surface is between 1.0 and 6.0 in units of the wavelength of the electromagnetic optical field in the first medium, for example, between 2.0 and 5.0, such as between 3.0 and 4.0.

The thickness of the nanocavity may, for example, be evaluated between the bottom surface and the top surface. The thickness of the nanocavity may also be referred to as the height.

The provision of a nanocavity having a thickness on the order of the wavelength of the electromagnetic eigenmode in the medium may ensure improved storage of the electromagnetic optical field inside the nanocavity.

In examples of the present disclosure, the nanocavity has a quality factor of the eigenmode at least 800, for example at least 1000, for example at least 1600, for example at least 2000, for example at least 4000, such as at least 8000.

In some embodiments, the nanocavity's Q factor is measured or calculated in relation to the nanocavity in isolation, i.e., it is the intrinsic Q factor of an isolated cavity. For example, a theoretically calculated Q factor in which no other structures are included in the calculation than the nanocavity itself. In some other embodiments, the nanocavity's Q factor is measured or calculated in relation to the nanocavity integrated with an optical system. For example, a Q factor of the nanocavity disposed on a silicon oxide substrate.

In examples of the present disclosure, the nanocavity has a mode volume with respect to the eigenmode of the electromagnetic optical field of at most 2, for example, at most 1, such as at most 0.5 in units of (wavelength/n)³.

In examples of the present disclosure, the nanocavity has a Q/V factor with respect to the eigenmode of at least 600, for example at least 1000, for example at least 2000, for example at least 3000, for example at least 6000, for example at least 10000, such as at least 30000, in units of (wavelength/n)⁻³.

Here, “Q” is the Q factor and “V” is the mode volume. Hence, in other words, the nanocavity may, for example, have a ratio of the Q factor to the mode volume of at least 1000 in units of (wavelength/n)⁻³.

The unit of wavelength/n corresponds to the wavelength of the electromagnetic eigenmode in the medium (the first medium) of the nanocavity.

In examples of the present disclosure, the nanocavity has a structural footprint of at most 10 in units of squared wavelength of the electromagnetic optical field in vacuum, for example at most 7, for example of at most 5, for example of at most 4, such as at most 3 in units of squared wavelength of the electromagnetic optical field in vacuum.

In examples of the present disclosure, the nanocavity has a Q/(VS) factor with respect to the eigenmode of at least 1000 in units of (n³/wavelength⁵), for example of at least 3000, for example of at least 5000, for example of at least 8000, such as at least 12000 in units of (n³/wavelength⁵).

Here, “Q” is the Q factor, “V” is the mode volume, and “S” is the structural footprint of the nanocavity. The wavelength is that of the electromagnetic optical field in vacuum, and “n” is the refractive index of the first medium.

In examples of the present disclosure, the at least one nanostructure is shaped and formed to provide sub-wavelength confinement of the electromagnetic optical field.

In examples of the present disclosure, each of the at least one nanostructure comprises a slanted channel of the first medium having an interface with the second medium, wherein the slanted channel has a transverse width that gradually increases away from a center point of the slanted channel.

The slanted channel may, for example, have a lengthwise extension along a longitudinal axis, where the direction of the transverse width is perpendicular to the lengthwise extension and the longitudinal axis. For example,, the direction of the longitudinal axis may correspond to the direction in which the two plates are geometrically connected. The direction along which the transverse width is measured may typically be substantially perpendicular to the direction of the electric field in the center of the slanted channel and/or the longitudinal axis. Away from the center point of the slanted channel, along the direction in which the channel lengthwise extends, the transverse width gradually increases. Hence, at the center point of the slanted channel, the transverse width is smaller than away from the center point of the slanted channel.

In examples of the present disclosure, each of the at least one nanostructure comprises two subsections tapering towards a center point of the nanostructure.

In examples of the present disclosure, the transverse width increases at an angle between 10 degrees and 50 degrees, measured at the center point of the slanted channel and along a longitudinal direction of the slanted channel.

In some embodiments, this transverse width increases at an angle between 15 and 35 degrees, for example, between 20 and 30 degrees.

In examples of the present disclosure, the slanted channel has a transverse width smaller than a wavelength of the electromagnetic optical field in the first medium by at least a factor of 4, for example at least a factor of 40, such as at least a factor of 400.

The provision of a certain minimum transverse width at some location of the slanted channel, such as at the center of the slanted channel, may advantageously ensure a particularly small mode volume.

The transverse width of the slanted channel can, for example, be measured in a direction transverse to the longitudinal direction of the slanted channel and/or in a direction between two interfaces between the first medium of the slanted channel and the second medium of its surroundings.

In examples of the present disclosure, the at least one nanostructure is at least one tipped nanostructure, at least one bowtie-shaped nanostructure, at least one hourglass-shaped nanostructure, and/or at least one cuneate-shaped nanostructure.

Each of these exemplary nanostructures constitutes a slanted channel with a transverse width that gradually increases away from the center of the slanted channel.

Another example of a viable nanostructure is a slit, for example an elongated slit constituted by the second medium within the first medium. In examples of the present disclosure, the nanocavity is shaped as a circular disc.

In examples of the present disclosure, each of the at least one nanostructure is formed by two gaps in the first medium, for example wherein the gaps are formed by the second medium to thereby provide interfaces between the first medium and the second medium.

In examples of the present disclosure, each of the gaps is completely surrounded by the first medium in a plane between the top surface and the bottom surface the planar geometrical shape.

Two gaps may, for example, shape each nanostructure. Examples of such gaps are air gaps. As a further example, such two gaps of the second medium may thereby establish a slanted channel of the first medium.

In examples of the present disclosure, the at least one nanostructure is at least two nanostructures such that the bound state in the continuum provides the spatial concentration and temporal storage of the electromagnetic optical field at both of the at least two nanostructures via the eigenmode of the electromagnetic optical field.

A circular disc is one possible geometrical shape that can be employed to host a BIC. Any nanostructure can, for example, be implemented as a slanted channel of the first medium having an interface with the second medium, wherein the second medium of the nanostructure is formed by gaps in the nanocavity.

In comparison with other geometries shaped to host a BIC, a circular disc is relatively simple, which is advantageous.

Moreover, a circular disc may permit the implementation of several nanostructures, for example, two nanostructures, three nanostructures, four nanostructures, or more than four nanostructures. Such several nanostructures may, for example, be implemented in a symmetrical pattern such that the nanostructures exhibit rotational and/or mirror symmetry in the nanocavity. The BIC may then provide spatial concentration and temporal storage of the electromagnetic optical field at each of these nanostructures.

In examples of the present disclosure, a thickness of the circular disc perpendicularly to and measured between the bottom surface and the top surface is between 0.9 and 5 in units of wavelength of the electromagnetic optical field in the first medium, for example between 1 and 4, such as between 2 and 3.

In examples of the present disclosure, the circular disc has a diameter between 1.0 and 5.0 in units of wavelength of the electromagnetic optical field in the first medium, for example between 1.5 and 3.5, such as between 2.0 and 2.5.

Preferable spatial concentration and temporal storage may be obtained by manufacturing the circular disc with a diameter corresponding to approximately two wavelengths and/or a thickness of approximately two and half a wavelength (in units of the wavelength of the electromagnetic optical field in the first medium).

In examples of the present disclosure, the nanocavity is shaped by at least two resonator segment plates which are optically coupled via the at least one nanostructure arranged between the at least two resonator segment plates.

Compared with having a nanocavity shaped by a circular disc, another possible geometrical shape of the nanocavity is to form the nanocavity by at least two resonator segment plates which are optically coupled via the nanostructure, which are then arranged between the at least two resonator segment plates.

A resonator segment plate may be understood as a plate-shaped segment of a resonator. The at least two resonator segment plates can collectively form a resonator, i.e., the nanocavity. Alternatively, a resonator segment plate may be referred to as a plate-shaped resonator segment or simply a resonator segment. Typically, the resonator segment plates are plate-shaped, the two resonator segment plates being shaped to share the top surface and the bottom surface of the nanocavity. The at least two resonator segment plates are optically coupled via the nanostructure because the relevant electromagnetic optical field is distributed across both the two resonator segment plates and linked via the nanostructure.

Embodiments of the invention based on resonator segment plates typically have two resonator segment plates. However, some alternative embodiments may have more than two resonator segment plates.

With two resonator segment plates, such nanocavities may, for example, resemble the shape of an infinity symbol “o”. However, typical embodiments will often have a more detailed structure. In particular, the two resonator segment plates can have non-trivial outer perimeters dented to optimize the BIC, thereby, or more specifically, the Q factor and the mode volume.

Nanocavities formed by such geometrical shapes typically have a planar top surface parallel to a planar bottom surface.

Both the resonator segment plates and the nanostructure are typically formed by a high-index medium, which is then surrounded by a low-index medium.

As described herein, nanocavities formed by two resonator segment plates can exhibit advantageous spatial concentration and temporal storage of the electromagnetic optical field. To some extent, the shape of some of the nanocavities resembles the shape of light propagating in a conventional concentric optical cavity formed by two mirrors having radii equal to half the cavity length. A conventional concentric optical cavity spatially concentrates and temporarily stores light in its center. This observation may indicate why such nanocavities can potentially provide advantageous spatial concentration and temporal storage of the electromagnetic optical field.

Nevertheless, it is not obvious that a nanocavity formed by two resonator segment plates geometrically connected via a nanostructure, such as a tapered nanostructure, can provide an improved nanocavity structure. An ordinary optical cavity is formed by conventional mirrors. In contrast, in preferred embodiments of the invention, the nanocavity is formed entirely by a high-index medium in which the electromagnetic optical field can be stored. Instead of conventional mirrors such as metal-coated or Bragg reflector-based mirrors, the preferable embodiments of the invention rely on the geometry of a resonator segment plate to ensure that a resonator is formed by the nanocavity via a BIC. In other words, preferably, each resonator segment plate forms a part (i.e., a segment) of a resonator. Further, in contrast to a conventional concentric optical cavity, an improved Q factor can be obtained by having an outer perimeter of the two segment plates with a dented non-trivial shape, for example, a dented circular shape. Such dented shapes can be introduced to improve the BIC. Moreover, typical embodiments have a parallel top and bottom surface, which is typically not the case for conventional optical cavities.

In examples of the present disclosure, the second medium comprises two tapered sections located between the at least two resonator segment plates and arranged on both sides of the at least one nanostructure.

Such two tapered sections of a low-index medium located between the resonator segment plates and arranged on both sides of the nanostructure can potentially improve spatial concentration or storage of the electromagnetic optical field at the nanostructure.

In examples of the present disclosure, the at least two resonator segment plates are mirror images of each other.

Symmetrical resonator segment plates may provide improved spatial concentration and temporal storage.

In examples of the present disclosure, each of the at least two resonator segment plates is associated with an outer perimeter, wherein the outer perimeter of each of the at least two resonator segment plates has a dented shape to provide the bound state in the continuum.

As described previously, a BIC typically relies on the destructive interference of two nanocavity modes. Such destructive interference can be tuned by altering the nanocavity's geometry. In particular, the provision of resonator segment plates with dented shapes, such as dented circular shapes, can improve the BIC, namely the Q factor thereof. Besides, the dented structure does not need to contain any holes patterned through within the segment, facilitating the nanofabrication.

A side contribution the dented shape can possibly provide is that it removes or suppresses the multiple whispering gallery-like modes within the original round disc segment plate. These whispering gallery-like modes are typical of relatively high Q-factor and inevitably present in dielectric cylinders or discs, so any modes engineered to have strong field concentration in the nanostructure in a cylinder or disc-shaped nanocavity tends to suffer from mode competition with these whispering gallery modes of nearby frequency. It should be noted that a whispering gallery mode typically cannot be strongly localized at the nanostructure.

In examples of the present disclosure, each of the at least two resonator segment plates is associated with a center of mass and an average radius of an outer perimeter evaluated from the center of mass, wherein the average radius is between 1.0 and 2.0 in units of wavelength of the electromagnetic optical field in the first medium, for example between 1.2 and 1.8, such as between 1.4 and 1.6.

A center of mass and an average radius is one approach to quantify the geometry of the resonator segment plates. The individual resonator segment plates can be analyzed by introducing a hypothetical division of the nanocavity in a center plane between the two resonator segment plates and considering the resulting two parts of the nanocavity on either side of the center plane. Such a division will typically pass through the nanostructure. However, for the sake of simplicity, a part of the nanostructure can be considered as a part of a resonator segment plate, for example, when evaluating a center of mass and various radii of a resonator segment plate.

The provision of an average radius in a specific range may ensure improved spatial concentration and/or temporal storage of the electromagnetic optical field. In particular, an average radius on the order of 1.5 wavelengths in the first medium, corresponding to a diameter of approximately 3.0 wavelengths in the first medium, has been found to provide improved temporal storage.

In examples of the present disclosure, each of the at least two resonator segment plates is associated with a center of mass, and an average radius of an outer perimeter evaluated from the center of mass, wherein a ratio of:
a distance between the at least two resonator segment plates evaluated from the center of mass of each of at least the two resonator segment plates; and
the average radius is from 1.4 to 3.5, for example from 1.6 to 3.3, such as from 1.8 to 3.0.

A distance between the two resonator segment plates in terms of the average radius is also an approach to quantify the geometry of the resonator segment plates.

Alternatively, the distance may be quantified in terms of the wavelength. That is, in some embodiments of the invention, each of the two resonator segment plates is associated with a center of mass, wherein a ratio of: a distance between the two resonator segment plates evaluated from the center of mass of each of the two resonator segment plates; and wavelength of the electromagnetic optical field in the first medium is from 2 to 8, for example from 3 to 7, such as from 4 to 6.

The provision of a distance between the center of mass of the two resonator segment plates, which is approximately two average radii or approximately four wavelengths (in the first medium), may ensure improved storage of the electromagnetic optical field.

In examples of the present disclosure, each of the at least two resonator segment plates is associated with:
a center of mass:
an average radius of an outer perimeter evaluated from the center of mass; and
a lower radius boundary of the outer perimeter evaluated from the center of mass;
wherein a ratio of the lower radius boundary and the average radius is from 0.4 to 0.9, for example from 0.5 to 0.8.

In examples of the present disclosure, each of the at least two resonator segment plates is further associated with an upper radius boundary of the outer perimeter evaluated from the center of mass, wherein a ratio of the upper radium boundary and the average radius is from 1.1 to 1.6, for example from 1.2 to 1.5.

Boundaries of upper and/or lower radii relative to the average radius are also a possible approach to quantifying the structure of a nanocavity.

The provision of the above-exemplified boundaries may potentially ensure improved storage of the electromagnetic optical field.

In examples of the present disclosure, each of the at least two resonator segment plates has a volume between 10 and 60 in units of (wavelength/n)³, for example, a volume between 20 and 50 in units of (wavelength/n)³, such as between 30 and 40 in units of (wavelength/n)³.

In examples of the present disclosure, the nanocavity has a central axis perpendicular to the bottom surface and the top surface and located in a geometrical center of the nanocavity, wherein the nanocavity is rotationally symmetric around the central axis.

In examples of the present disclosure, the geometrical center is located within the at least one nanostructure.

In examples of the present disclosure, the at least two resonator segment plates are located on separate sides of the geometrical center.

In examples of the present disclosure, each of the at least two resonator segment plates is non-convex.

A geometrical shape being non-convex means that a straight line can be found which meets the boundary of one of the resonator segment plates more than twice. Similarly, a line segment between two boundary points of such a resonator segment plate can be found which lies outside the resonator segment plate.

In examples of the present disclosure, the at least two resonator segment plates comprise a first segment plate and a second segment plate, wherein a whole interior of the first segment plate is visible from at least one first point without crossing any outer boundary of the first resonator segment plate and a whole interior of the second segment plate is visible from at least one second point without crossing any outer boundary of the second resonator segment plate.

In examples of the present disclosure, the whole interior of the first segment plate and the whole interior of the second segment plate are not visible from the central axis without crossing any outer boundary of the at least two resonator segment plates.

In geometry, a shape in which a whole interior is visible from at least one point without crossing any outer boundary may be referred to as a star domain. Hence according to some embodiments of the invention, each of the at least two resonator segment plates is individually a star domain, but the entire nanocavity is not a star domain. These properties can, for example, arise from the two resonator segment plates only being geometrically connected via the nanostructure. Such a structure has been found to be capable of hosting a BIC.

In examples of the present disclosure, the optical system further comprises a waveguide, wherein the eigenmode of the electromagnetic optical field is coupled to the waveguide.

The electromagnetic optical field may be coupled to the waveguide in the sense that one end of the waveguide is positioned within the near field region of the electromagnetic optical field of the nanocavity and/or within 1 or 2 wavelengths of the electromagnetic optical field in the second medium relative the outer perimeter of the nanocavity or relative to the center of the nanostructure or nanocavity.

In examples of the present disclosure, the waveguide is arranged within planes spanned by the top surface and the bottom surface of the nanocavity.

By coupling the nanocavity eigenmode to a waveguide, the optical system is configured for optical communication with the surroundings.

The eigenmode of the electromagnetic optical field of the nanocavity may, for example, be coupled to the waveguide by locating the waveguide in a near-field evanescent tail of the eigenmode. Hence, out-coupling the eigenmode is straightforward and flexible, which is important for chip-scale applications.

In examples of the present disclosure, the nanocavity is isolated with respect to any other nanocavities.

In examples of the present disclosure, the nanocavity is configured to host the bound state in the continuum in isolation from any other nanocavities.

Systems with arrays of nanoparticles have previously been proposed for the manipulation of electromagnetic fields. However, the current invention does preferably not rely on such arrays but is configured to, e.g., host a BIC independently of other nanocavities or nanoparticles. Hence, the nanocavity is preferably not part of an array of nanocavities.

Isolation or independency of other nanocavities or nanoparticles may, e.g., be quantified by wavelength. For example, in preferable embodiments, no additional nanocavities are present relative to the perimeter of the nanocavity within one or two wavelengths of the BIC mode in the (low-index) second medium. Naturally, other components can be present, e.g., a waveguide, pumping means, substrate, etc.

In examples of the present disclosure, the optical system further comprises a gain medium.

In examples of the present disclosure, the gain medium is arranged at the at least one nanostructure.

In examples of the present disclosure, the optical system further comprises a pumping source for transferring energy to the gain medium to thereby establish a laser system in which the nanocavity constitutes a laser cavity.

The provision of a gain medium enables the nanocavity to be utilized as a laser cavity for, e.g., a nanolaser. By arranging the gain medium at the at least one nanostructure, where the spatial concentration of the electromagnetic optical field occurs, the eigenmode is efficiently coupled to the gain medium.

A gain medium arranged at a nanostructure may, for example, be arranged at a center of the nanostructure, at a central plane of mirror symmetry between the two resonator segment plates, at an interface between a first medium and a second medium, within a slanted channel of the nanostructure, or within a (spherical) volume around the center equal to the mode volume of the eigenmode. Preferably, the gain medium is entirely encapsulated inside the first medium.

In examples of the present disclosure, the pumping source is electrical.

By ‘wherein the pumping source is electrical’ may be understood that the gain medium is electrically pumped (as opposed to optically pumped).

An electrical pumping source may permit advantageous integration of the laser system into integrated circuits.

In examples of the present disclosure, the optical system further comprises a substrate, such as a silicon substrate, wherein the nanocavity is arranged on the substrate.

Such a configuration may permit straightforward integration of the optical system into existing technology platforms.

A second aspect of the present disclosure relates to a method for processing an electromagnetic optical field, the method comprising the steps of:
shaping and forming a nanocavity such that the nanocavity hosts a bound state in the continuum of the electromagnetic optical field;
providing the nanocavity with at least one nanostructure shaped to provide sub-wavelength confinement of the electromagnetic optical field; and
supplying the electromagnetic optical field to the nanocavity such that the electromagnetic optical field is spatially concentrated and temporarily stored at the at least one nanostructure via an eigenmode of the electromagnetic optical field in the nanocavity.

Any advantages or effects provided by an optical system according to the first aspect may similarly be provided by the method according to the second aspect.

Note that embodiments of the invention are not limited to a particular sequence of performing the steps. For example, the step of shaping and forming the nanocavity can be performed at least partly simultaneously with the step of providing the nanocavity with a nanostructure. Such shaping and providing may be performed numerically and iteratively, upon which a physical nanocavity is manufactured.

In examples of the present disclosure, the nanocavity of the above-outlined method is a nanocavity of an optical system according to the first aspect of the present disclosure or any examples thereof.

### BRIEF DESCRIPTION OF THE DRAWINGS

Embodiments of the invention will now be further described by reference to the accompanying drawings, in which:

FIG. 1 schematically illustrates an exemplary embodiment of the invention,

FIG. 2 illustrates an embodiment of the invention in which the nanocavity is shaped by two resonator segment plates,

FIGS. 3a-c illustrate the electric field of an eigenmode in three exemplary nanocavities,

FIGS. 4a-f illustrate the electric field of an eigenmode in additional exemplary nanocavities,

FIG. 5 illustrates another embodiment of the invention in which the nanocavity is shaped by two resonator segment plates,

FIG. 6 illustrates an embodiment of the invention in which the nanocavity is shaped as a circular disc,

FIG. 7 illustrates additional examples of nanocavities shaped by two resonator segment plates,

FIGS. 8a-b schematically illustrate top and angled views of a nanocavity in comparison with various radii of a resonator segment plate,

FIGS. 9a-c illustrate various examples of a nanostructure shaped to provide sub-wavelength confinement,

FIG. 10 illustrates a flow chart of an optimization process for providing an optimized geometry of a nanocavity,

FIG. 11 illustrates a manufacturing process of a nanocavity for a laser,

FIGS. 12a-c illustrate various exemplary optical systems comprising a nanocavity having a nanostructure,

FIGS. 13a-f illustrate the electric field of an eigenmode in further exemplary nanocavities, and

FIGS. 14a-e illustrate evolution of various parameters for varying thickness of an exemplary nanocavity, thereby highlighting the presence of a bound state in the continuum.

### DETAILED DESCRIPTION

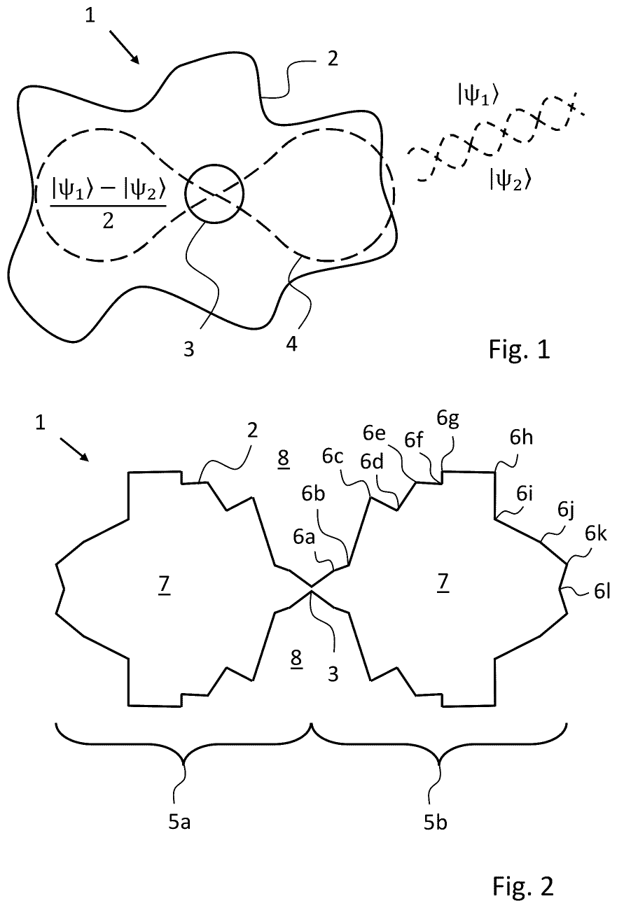

FIG. 1 schematically illustrates an exemplary embodiment of the invention. The embodiment consists of an optical system 1 comprising a nanocavity 2 made of indium phosphide (InP).

The nanocavity 2 hosts various eigenmodes of the electromagnetic optical field. One of these eigenmodes 4 is a BIC. In practice, this BIC arises due to a coupling between two modes for which the far-field components destructively interfere.

The coupling and interference of the modes are indicated in the drawing, in which the two modes are denoted “|ψ₁ [symbol] ” and “|ψ₂ [symbol] ”, respectively. The destructive interference of the far-field components of the modes is schematically indicated on the right-hand side of the figure by the two dashed sinusoidal curves of the opposite phase. The two modes are coupled in the nanocavity 2, giving rise to the eigenmodes “(|ψ₁ [symbol] ±|ψ₂ [symbol] )/2” (more accurately (α1|ψ₁)+α2|ψ₂ [symbol] )/2).

The nanocavity 2 has a nanostructure 3 shaped to provide sub-wavelength confinement of the eigenmode 4, which is a BIC. This is schematically illustrated in the figure by the eigenmode 4 having an antinode-like feature in the center of the nanostructure 3. In practice, the sub-wavelength confinement is established via shaping the overall nanocavity geometry together with the nanostructure to provide electromagnetic boundary conditions between two mediums having different refractive indices. As a result thereof, the intensity of the electromagnetic optical field at the nanostructure 3 is significantly larger than the intensity at other parts of the eigenmode.

Thereby, the BIC is capable of providing spatial concentration and temporal storage of the electromagnetic optical field at the nanostructure 3 via an eigenmode 4 of this nanocavity.

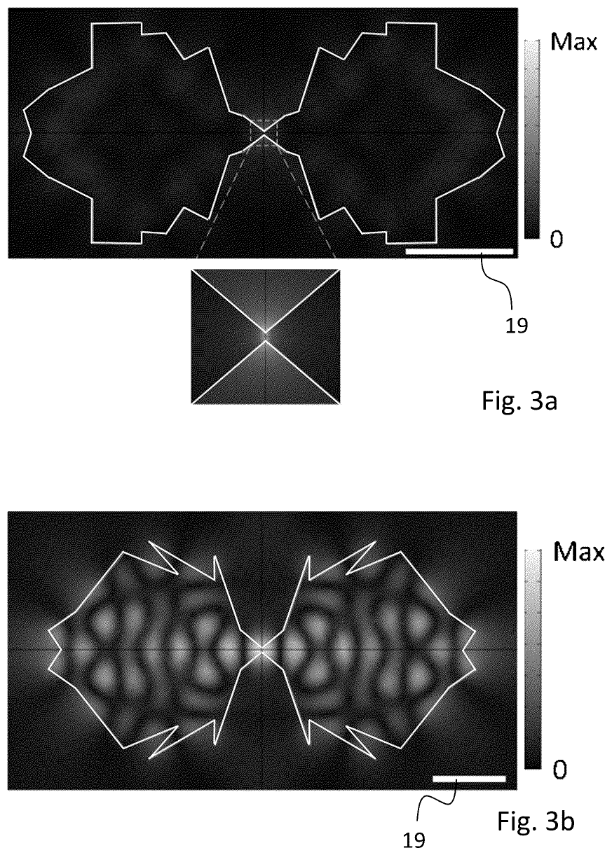

FIG. 2 illustrates an embodiment of the invention in which a nanocavity 2 is shaped by two resonator segment plates 5a-5b. In the illustration, the first resonator segment plate 5a constitutes the left-hand side of nanocavity 2, and a second resonator segment plate 5b constitutes the right-hand side of nanocavity 2.

The right-most part of the first resonator segment plate 5a has a tapered shape which narrows down the width of the first resonator segment plate towards the center of nanocavity 2. Similarly, the left-most part of the second resonator segment plate 5b also has a tapered shape which narrows down the width of the second resonator segment plate towards the center of the nanocavity. The tapered shape of the first resonator segment plate and the tapered shape of the second resonator segment plate unite centrally to shape a nanostructure 3 which is capable of providing sub-wavelength confinement. Further, the nanostructure 3 thereby optically couples the two resonator segment plates 5a-5b.

The nanostructure 3 defines a longitudinal direction in which it couples the two resonator segment plates 5a-5b (horizontal direction in the illustration), and a transversal direction perpendicular to the longitudinal direction (vertical direction in the illustration).

The nanocavity 2 is illustrated in a top view. It has a planar bottom surface and a planar top surface parallel to the bottom surface and parallel to the plane of the illustration. These planar surfaces thereby provide the nanocavity with a planar geometrical shape.

The nanocavity 2 is shaped such that the nanostructure 3 is centrally located in the nanocavity 2. More specifically, the nanocavity has a central axis (perpendicular to the plane of the illustration of FIG. 2) located in the geometrical center of the nanocavity 2, and this central axis is then also located in the center of the nanostructure 3. The entire nanocavity 2, including the nanostructure 3, is rotationally symmetric around this central axis. Further, the nanocavity has mirror symmetry with two perpendicular planes of symmetry overlapping with the central axis, in which a first plane of symmetry extends in the longitudinal direction of the nanostructure 3 (horizontal direction in the illustration), and a second plane of symmetry extends in the transversal direction of nanostructure 3 (vertical direction in the illustration).

The nanocavity 2 is formed by a first medium 7 having a peripheral interface with a second medium 8. The first medium 7 has a larger refractive index than the second medium 8 surrounding the first medium 7. The wavelength at which the refractive index of the first medium 7 and the refractive index of the second medium 8 may be compared is the wavelength of the electromagnetic optical field which the nanocavity is configured to process, host, store, and/or confine. In this particular embodiment, the first medium is InP and the second medium is a vacuum, atmospheric air, or inert gas.

In practice, the geometry of this embodiment has been adjusted so as to configure the nanocavity to concentrate and store the electromagnetic optical field of the BIC mode having a wavelength of 1576 nm (in vacuum). The refractive index of InP at 1576 nm is approximately 3.17. Hence, the wavelength of the electromagnetic optical field in the first medium is approximately 497 nm.

In the following, various coordinates are provided in units of the wavelength of the electromagnetic optical field in the first medium. It should be noted that the wavelengths of their BIC mode are not identical, and each configuration is scaled with respect to their normalized wavelength (wavelength in vacuum divided by the refractive index in the first medium) of their own eigenmode.

The nanostructure 3 has a transverse width of 0.02 (in the transversal direction) at its narrowest point at the center of the nanostructure. This width corresponds to the width of the first medium between peripheral interfaces with the second medium.

The rest of the geometry of the nanocavity 2 is described in terms of coordinates 6a-6l of vertices of the nanocavity 2 relative to the center (i.e., central axis provides origin) of the nanocavity 2 and of the nanostructure 3. The intersections between the plane of the illustration and the symmetry planes are used for axes of the coordinates, such that the x-axis extends in the horizontal direction of the illustration and the y-axis extends in the vertical direction of the illustration. Only the coordinates of a subset of vertices are provided, with the coordinates of the rest being derivable from the symmetry of the nanocavity 2. Each of the vertexes coordinates 6a-6l provided in the following is connected to neighboring vertices by straight lines, providing the peripheral interface between the first medium 7 and the second medium 8.

The vertex coordinates are as follows: 6a: (0.296, 0.265); 6b: (0.51,0.327); 6c: (0.824,1.268); 6d: (1.176,1.084); 6e: (1.45,1.48); 6f: (1.81,1.45); 6g: (1.81,1.63); 6h: (2.53,1.62); 6i: (2.53,0.957); 6j: (3.195,0.65); 6k: (3.54,0.346); 6l: (3.44,0).

Further, the height of the nanocavity between the bottom surface and the top surface is 3.14.

This particular set of coordinates is provided to shape the nanocavity such that it hosts a BIC for the electromagnetic optical field having a wavelength in the vacuum of 1576 nm. As a result, each of the resonator segment plates 5a-5b has an outer perimeter with a dented shape.

The resulting BIC has a calculated Q factor of 6246. The mode volume of this state is 0.5 (1/n)³, where λ is the wavelength of the electromagnetic optical field of the BIC mode (1576 nm in this example) in vacuum and n (3.17) is the index of InP.

The particular shape illustrated in FIG. 2 is merely one example of many possible nanocavities shaped by two resonator segment plates with a large Q-factor. A general finding of the present disclosure is that nanocavities with two resonator segment plates having (non-trivial) outer perimeters with dented shapes can potentially provide an improved BIC, for example, in terms of a Q factor and in comparison with two resonator segment plates having a standard geometrical shape, such as a substantially circular shape, or a cuboid shape (i.e., without dents around the outer perimeter). Other examples are provided elsewhere in this disclosure. Customarily, the exact coordinates or geometry of the dented shapes may be adjusted or found based on numerical optimization.

Another finding is that an approximate diameter of each of the resonator segment plates 5a-5b being on the order of three wavelengths of the electromagnetic optical field in the first medium 7 tends to provide an improved Q-factor. In the illustrated example, this is evident from the last vertex coordinate 6l being located at (3.44,0), and the (seventh) vertex coordinate 6g being located at (1.81,1.63). These coordinates indicate the diameter of the resonator segment plates 5a-5b in the horizontal and vertical directions, respectively.

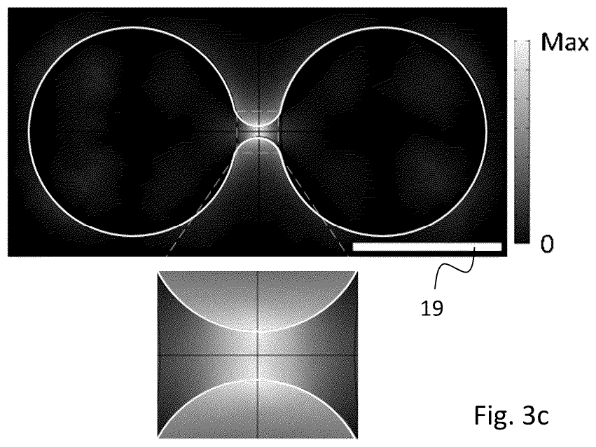

FIGS. 3a-c illustrates the electric field of an eigenmode in three exemplary nanocavities. Specifically, each of the three subfigures provides a heat map of the modulus of the electric field IEl. In each of the subfigures, the electric field is normalized relative to the maximum electric field of the relevant eigenmode. In addition, the insert at the bottom of FIG. 3a provides a zoomed-in view of the central nanostructure of the illustrated nanocavity. In each subfigure, the nanocavity's outer perimeter is drawn using white lines. The scale bar 19 in each subfigure corresponds to half of the resonant wavelength (in vacuum) for the electromagnetic optical field of the eigenmode for the respective nanocavity.

The nanocavity illustrated in FIG. 3a is the same nanocavity as illustrated in FIG. 2. In contrast, the nanocavity illustrated in FIG. 3b has a geometry which does not support a BIC mode.

The embodiment illustrated in FIG. 3a clearly has its largest electric field at the tapered nanostructure in the center of the nanocavity. This is particularly evident from the bright shading in the center of the bottom insert of FIG. 3a in comparison with the relatively dark shading distributed throughout the rest of the nanocavity. Hence, a maximum electric field is present at the center of the tapered nanostructure. This electric field at this maximum has a magnitude far greater than any other electric field of the illustrated mode.

In contrast, the embodiment illustrated in FIG. 3b does not have an equally small region in which the electric field is concentrated. Instead, small local maxima of the electric field of comparable magnitude are distributed evenly throughout the nanocavity.

In addition, note that the electric field in FIG. 3a is primarily polarized in the plane of the figure. In comparison, the electric field in FIG. 3b is primarily polarized perpendicular to the plane of the figure.

Generally, polarization within the planar geometrical shape, i.e., parallel to the top and bottom surface, of a nanocavity is advantageous since this permits improved integration of the nanocavity into applications of light sources, modulators, and photodetectors since an active region based on quantum wells or quantum dots will spread in a plane parallel to the planar surfaces of the planar geometrical shape.

As evident from FIG. 2 and FIG. 3a, the embodiment illustrated therein provides sub-wavelength confinement of the electromagnetic optical field in the nanostructure. Further, the nanocavity is shaped and formed to host a BIC to provide spatial concentration and temporal storage of the electromagnetic optical field at the nanostructure via an eigenmode of the nanocavity, i.e., the BIC.

In FIG. 3c, the two resonator segment plates have a substantially circular geometry coupled with a central nanostructure. This geometry is thus simple compared to the optimized geometry of the embodiment illustrated in FIG. 3a. The eigenmode can still be engineered to have strong sub-wavelength confinement at the tapered nanostructure, with the mode volume being 0.63 (λ/n)³ in the illustrated embodiment. However, due to the absence of BIC, the embodiment has a Q-factor of 70, which is low relative to other embodiments of the invention, for example, embodiments in which each resonator segment plate has a dented shape. This mode, with strong spatial concentration of the electromagnetic optical field at the nanostructure, also suffers mode competition of whispering gallery modes of the resonator segment plates at nearby frequencies having much higher Q factors.

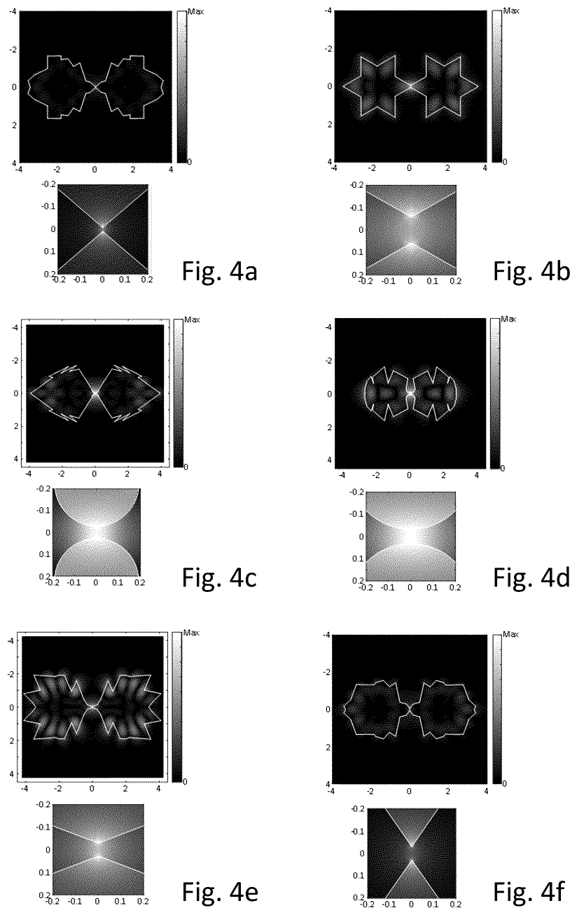

FIGS. 4a-f illustrate the electric field of eigenmodes in additional exemplary nanocavities. The subfigures are illustrated in style similar to the style used in FIGS. 3a-c, with each subfigure providing a heat map of the electric field |E| normalized with respect to a peak value, a bottom zoomed-in view of the central nanostructure. The coordinates are scaled with respect to the resonant wavelength (in the first medium) of the BIC eigenmode for the respective nanocavity.

The respective nanocavities of the subfigures have mode volumes V and Q factors as follows. FIG. 4a: Q=6246, V=0.5 (λ/n)³, FIG. 4b: Q=3855, V=0.9 (λ/n)³, FIG. 4c: Q=5078, V=0.81 (λ/n)³, FIG. 4d: Q=2001, V=0.65 (λ/n)³, FIG. 4e: Q=3500, V=1.77 (1/n)³, FIG. 4f: Q=8071, V=1 (1/n)³.

From these examples, it is evident that a wide number of resonator segment plate shapes can provide large Q factors and small mode volumes. The detailed shape of the resonator segment plates may vary considerably while still providing the desired effect.

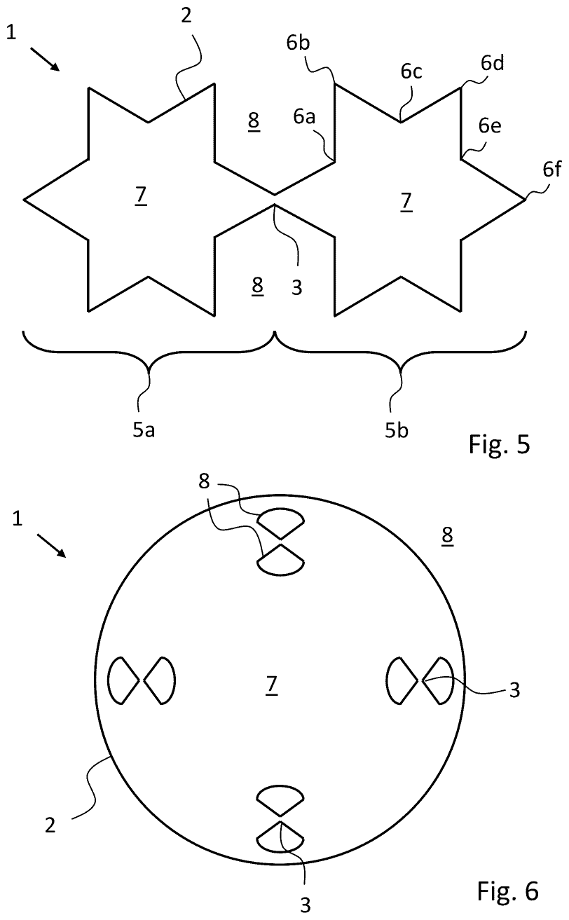

FIG. 5 illustrates another embodiment of the invention in which the nanocavity 2 is shaped by two resonator segment plates 5a-5b. The embodiment is illustrated in the same style as the illustration of FIG. 2, but the nanocavity itself has a different shape. Due to this same style, a description of various elements of the figure will not be repeated to not obscure the present disclosure with unnecessary repetitions. Instead, the vertex coordinates 6a-6f, and the resulting properties of the eigenmode established by this geometry are merely provided. Again, numbers are provided in units of the wavelength of the electromagnetic optical field of the BIC mode in the first medium, i.e., the high-index medium of the nanocavity.

The nanostructure 3 has a transverse width of 0.117 (in the transversal direction) at its narrowest point at the center of the nanostructure 3. This width corresponds to the width of the first medium 7 between peripheral interfaces with the second medium 8.

The vertex coordinates are as follows: 6a: (0.796,0.514); 6b: (0.796,1.58); 6c: (1.69,1.04); 6d: (2.50,1.51); 6e: (2.50,0.552); 6f: (3.36,0).

Further, the height of the nanostructure between the bottom surface and the top surface is 3.68.

The resulting BIC has a calculated Q factor of 3855. The mode volume of this state is 0.9 (%/n)³.

Generally, having more vertices tends to improve the properties of the nanocavity, as evidenced by a comparison of the embodiment of FIG. 2 and the embodiment of FIG. 5, given that the positioning of the vertices is optimized adequately.

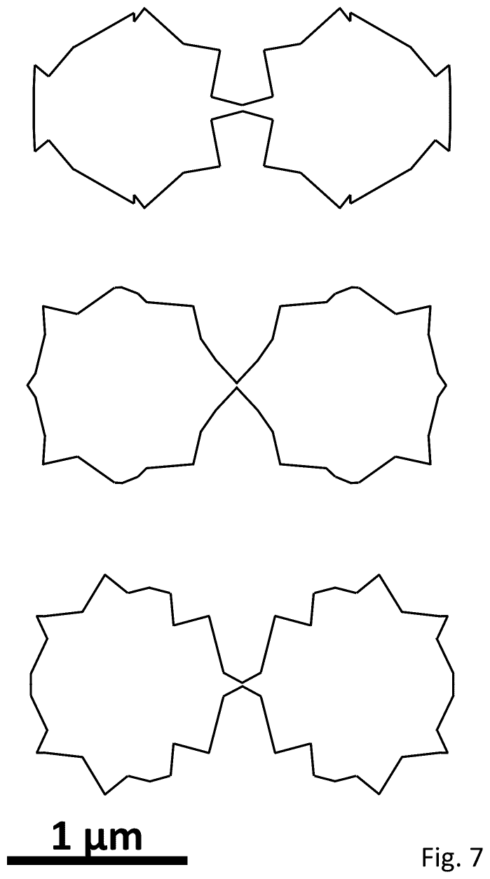

FIG. 6 illustrates an embodiment of the invention in which nanocavity 2 is shaped as a circular disc.

The disc itself is formed by a first medium 7 having a peripheral interface, with a second medium 8 having a lower refractive index than the first medium 7. Further, the circular disc has a planar bottom surface and a planar top surface parallel to the bottom surface and parallel to the plane of the illustration.

The nanocavity 2 has four tapered nanostructures 3. The BIC hosted by the nanocavity is configured to provide spatial concentration and temporal storage of the electromagnetic optical field at each of these four nanostructures 3. Further, each of the nanostructures 3 is shaped by interfaces between the first medium 7 and the second medium 8. These interfaces are provided by gaps in the first medium, with these gaps constituted by the second medium 8 and each of the gaps completely surrounded by the first medium 7. The second medium 8 of each nanostructure 3 is formed by two gaps in the nanocavity 3, i.e., gaps in the first medium 7 of the nanocavity 3.

The circular disc has a circular circumference. The nanostructures 3 are rotationally symmetrically distributed within the circular disc. In this particular embodiment, the rotational symmetry is 4-fold, but in other embodiments, the rotational symmetry may, e.g., be 2-fold. Each nanostructure 3 is oriented in an azimuthal direction (i.e., transverse to a radial direction) relative to the center of the circular disc. In other words, the longitudinal direction of each nanostructure is oriented in the azimuthal direction relative to the center of the circular disc. Such an orientation supports the spatial concentration of whispering gallery-like modes of the electromagnetic optical field in the nanocavity 2 on the nanostructures 3, which can be advantageous for circular disc-shaped nanocavities.

In this example, the circular disc is formed by InP and is configured to host a BIC of the electromagnetic optical field having a wavelength of 2=1550 nm in vacuum. In units of the wavelength of the BIC in the first medium, the circular disc has a height (perpendicular to the plane of the illustration) of 2.5, a radius of 1.12, and each of the four nanostructures 3 has a transverse width of 0.063. The angle formed by the tip of the second medium 8 in each of the gaps forming the nanostructures is 138°. The circular arc opposite the tip of the second medium in each of the gaps has a radius of 0.16.

Resultingly, the nanocavity has a calculated Q-factor of 930 and a mode volume of 1.1 (λ/n)³.

Note that embodiments of the invention shaped as a circular disc are not limited to a particular number of nanostructures. For example, in an embodiment of the invention, the nanocavity is shaped as a circular disc and has a single nanostructure located in the circular disc.

FIG. 7 illustrates additional examples of nanocavities shaped by two resonator segment plates. A scale bar is inserted to the bottom left, which applies to each illustrated nanocavity.

Each of the three embodiments is illustrated in the same style as the illustration of FIG. 2, but the nanocavities have different shapes, i.e., a different set of vertex coordinates. These different examples illustrate that the detailed shape of the nanocavity may vary considerably whilst still providing the desired effect. Nevertheless, it is straightforward to test whether a given nanocavity actually provides the desired effect, for example, via a numerical simulation or physical measurements on a nanocavity to obtain the Q factor and/or the mode volume.

A general finding of the present disclosure is that nanocavity shaped by two resonator segment plates generally appear to have improved properties, for example, improved Q factor, in comparison with other structures such as, e.g., a nanocavity shaped as a circular disc.

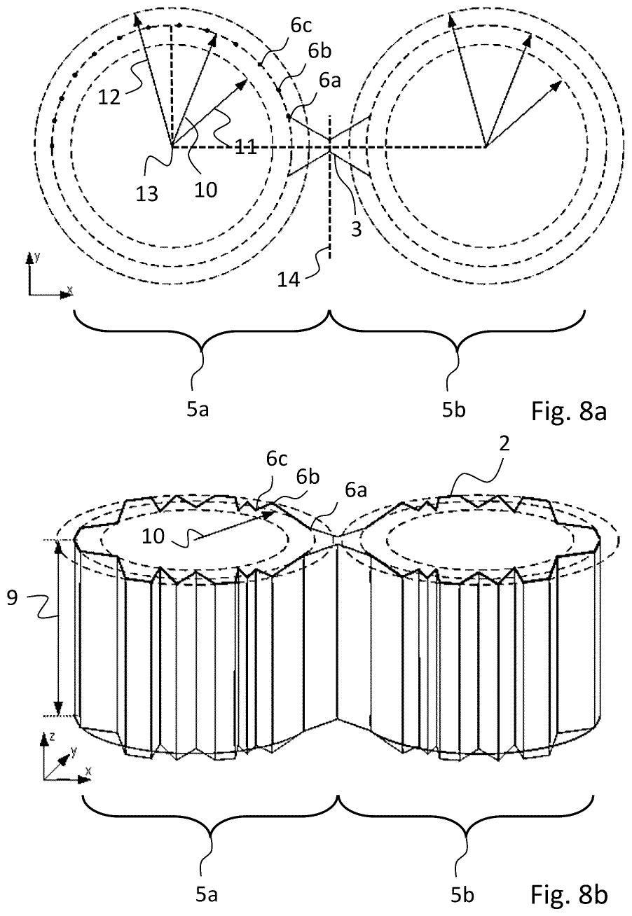

FIGS. 8a-b schematically illustrate top and angled views of a nanocavity 2 in comparison with various radii 10-12 of a resonator segment plate 5a.

In FIG. 8a, a schematic top view of the nanocavity is provided. For the sake of simplicity, only some of the vertex coordinates 6a-6c are provided with reference numerals (6a-6c). Further, the coordinates of all vertices are drawn such that each vertex has the same radius 10 relative to a center of mass 13 (see below).

In FIG. 8b, a schematic angled view of the nanocavity is provided. Again, only some of the vertices 6a-6c are provided with reference numerals. Here, the coordinates of all vertices do not have the same radius, such that the detailed three-dimensional structure of the nanocavity is visible.

One approach to quantify the structure of a resonator segment plate is through an average radius 10, and, optionally, via upper and/or lower radius boundaries 11,12. For the sake of evaluating such radii, a nanocavity may be divided into two halves, i.e., a first resonator segment plate 5a and a second resonator segment plate 5b. This division may be carried out through the center of the tapered nanostructure 3, for example, coinciding with a plane of mirror symmetry 14 between the two resonator segment plates 5a-5b. In the illustration, the part of the nanocavity on the left-hand side of plane 14 then constitutes the first resonator segment plate 5a, and the part of the nanocavity of the right-hand side of the plane constitutes the second resonator segment plate 5b.

For each resonator segment plate 5a-5b, a center of mass 13 can then be determined. In turn, based on the center of mass, the average radius 10 of a resonator segment plate can be determined. For the sake of simplicity, each of the vertexes coordinates 6a-6c in FIG. 8a have been illustrated so as to be positioned corresponding to the average radius 10, but as evident from other illustrations of the present disclosure, this is typically not the case.

The average radius is approximately 1.5 units of the wavelength of the BIC mode in the first medium.

The ratio of the distance between the two resonator segment plates 5a-5b is evaluated from the center of mass of each of the two resonator segment plates, and the average radius is approximately 2.5.

Further, a lower radius boundary 11 and/or an upper radius boundary 12 can be determined based on the average radius 10. Some preferable embodiments are shaped such that the vertex coordinates or the outer perimeter of a given resonator segment plate lies within such a lower radius boundary 11 and/or an upper radius boundary 12. Embodiments lying within such boundaries have generally been found to provide a large Q factor. Optionally, the central tapered nanostructure 3 may be excluded in an evaluation as to whether an outer perimeter 12 of a resonator segment plate lies within an upper radius boundary 12.

In practice, for the illustrated embodiment, a lower radius boundary 11 and an upper radius boundary 12 means that all the vertex coordinates 6a-c lie within the inner and outer dashed circles indicated by the arrows of the lower and upper radius boundaries.

The ratio of the illustrated lower radius boundary 11 and the average radius 10 is 0.85. Similarly, the ratio of the illustrated upper radius boundary 12 and the average radius 10 is 1.15.

FIG. 8b provides an angled view of the nanocavity, in which the dashed circles indicating upper and lower radius boundaries are still drawn. Note that all vertex coordinates 6a-c lie within these boundaries.

The figure further illustrates nanocavity thickness 9.

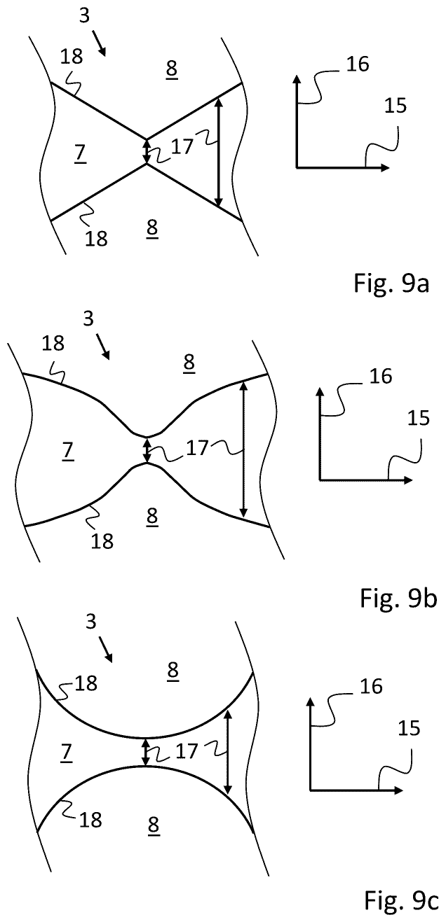

FIGS. 9a-c illustrate various examples of a tapered nanostructure 3 shaped to provide sub-wavelength confinement. These may each be employed in embodiments of the invention to provide sub-wavelength confinement of the electromagnetic optical field. FIG. 9a illustrates a tipped nanostructure, FIG. 9b illustrates a bowtie-shaped nanostructure, and FIG. 9c illustrates a cuneate-shaped nanostructure. The subfigures are each provided with arrows indicating a longitudinal direction 15 and a transversal direction 16.

Each of the illustrated nanostructures 3 comprises a slanted channel of a first medium 7 having an interface 18 with a second medium 8, wherein the slanted channel has a transverse width 17, which gradually increases away from the center of the slanted channel. In preferable embodiments of the invention, the slanted channel has a transverse width 17 smaller than the wavelength of the electromagnetic eigenmode in the first medium.

The different examples of nanostructures 3 shaped to provide sub-wavelength confinement illustrate that the detailed shape of a nanostructure may vary considerably in a manner difficult to define whilst still providing the desired effect. Nevertheless, it is straightforward to test whether a given nanostructure actually provides the desired effect, for example, via a numerical simulation of or physical measurements on a nanocavity to obtain a mode volume associated with the sub-wavelength confinement.

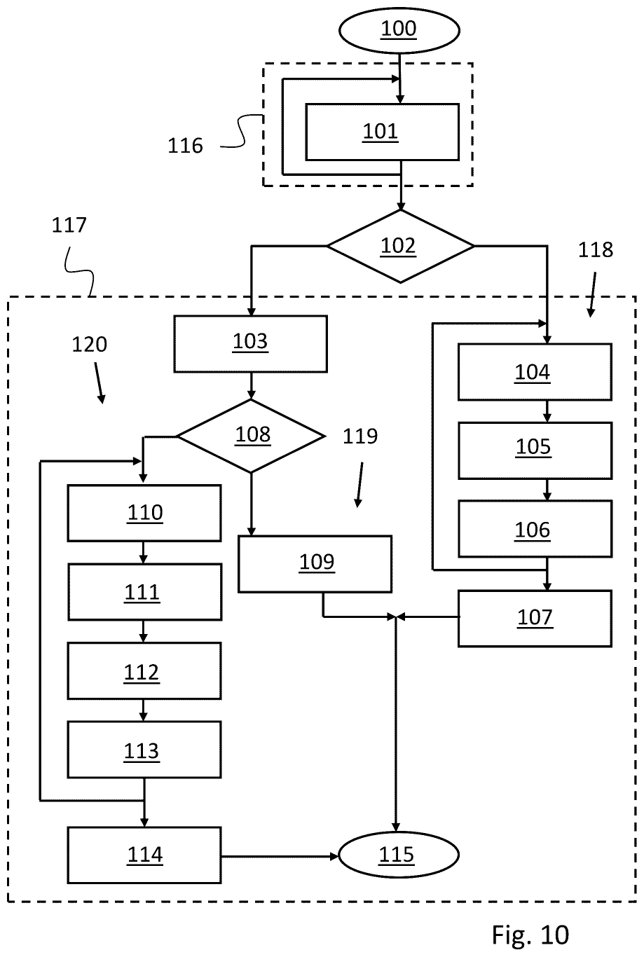

FIG. 10 illustrates a flow chart of an optimization process for providing an optimized geometry of a nanocavity.

The process consists of a preparation phase 116 and an optimization phase 117.

In the preparation phase 116, step 101 of performing full-wave simulations (e.g., FDTD) is performed m times (indicated by the cyclic arrow) with random sets of geometric input parameters Xᵢ={x_{i,1}, x_{i,2}, . . . x_{i,n}} (for example, vertex coordinates), generating m outputs Qⱼ (e.g., Q factor), where jϵ1~m. This eventually forms a data matrix for the input X_{1~m} and a vector for the output Q_{1~m}.

The optimization phase 117 can generally contain one of three different methods. In the illustration, each of the three methods is indicated by reference numerals “118”, “119”, and “120” and comprises a number of optimization steps, and a box in the flow diagram of the illustration indicates each step.

This method is based on a conventional optimization algorithm combined with full-wave simulations. Prior to arriving at the optimization phase, conditional step 102 determines the next path depending on whether a surrogate model is preferred or not. If a surrogate model is preferred, the optimization proceeds to step 103; if not, the optimization proceeds to step 104, corresponding to the first method of optimization 118.

In method step 104, the geometric input parameters Xⱼ={x_{j,1}, x_{j,2}, . . . x_{j,n}} are set up, and full-wave simulations are used to calculate an output Qⱼ.

In method step 105, new inputs Xⱼ and outputs Qⱼ are inserted into the existing data to update X_{1~j}→[X_{1~(j-1)}; Xⱼ] and Q_{1~j}→[Q_{1~(j-1)}; Qⱼ].

In method step 106, an optimization algorithm O is used to generate a new set of geometric parameters based on X_{1~j} and Q_{1~j}, i.e., O(X_{1~j}, Q_{1~j})→Xⱼ₊₁.

These steps 104-106 can then be repeated n times, and in a next step 107, the optimum point providing the optimum output, such as the largest Q-factor, in the whole data sheet X_{O} and Q_{O} can be found, thereby terminating the optimization in step 115.

If a surrogate model is preferred, the optimization algorithm proceeds to step 103, in which a surrogate model is generated f(Q_{1~m})=g(X_{1~m}) based on, e.g., a machine learning method.

After step 103, the optimization proceeds to conditional step 108. Here, suppose an artificial neural network is preferred. In that case, the optimization proceeds to the second optimization method 119 at step 109, an if an artificial neural network is not preferred, the optimization proceeds to the third optimization method 120 at step 110.

The second optimization method 119 used the surrogate model to predict a set of input parameters giving the best performance, e.g., the highest Q factor. The third optimization method 120 combines the two first optimization methods 118, 119, which can potentially provide a better result at the cost of performing additional numerical calculations.

At step 109, the optimum point in the landscape of f(Q_{1~m}) that maximizes the output Q, leading to X_{O} and Q_{O}, is found, thereby terminating the optimization in step 115.

At step 110, the geometric input parameters Xⱼ={x_{j,1}, x_{j,2}, . . . x_{j,n}} are set up, and full wave simulations calculate an output Qⱼ.

At step 111, new inputs Xⱼ and outputs Qⱼ are inserted into the existing data to update X_{1~j}→[X_{1~(j-1)}; Xⱼ] and Q_{1~j}→[Q_{1~(j-1)}; Qⱼ].

At step 112, the surrogate model is updated f(Q_{1~j})=g(X_{1~j}) based on, e.g., a machine learning method.

At step 113, an optimization algorithm O is used to predict a new set of geometric parameters based on the surrogate model O(f(Q_{1~j}), g(X_{1~j}))>Xⱼ₊₁.

These steps 110-113 can then be repeated n times, and in a next step 114, the optimum point in the landscape of f(Q_{1~m}) that maximizes the output is found, leading to X_{O} and Q_{O}, thereby terminating the optimization in step 115. The second method of optimization 119 is usually the fastest, but the performance may not be as good as for the first or third methods of optimization 118,120. Note that the above-presented method is merely a possible approach by which the geometry of a nanocavity can be determined and/or optimized numerically.

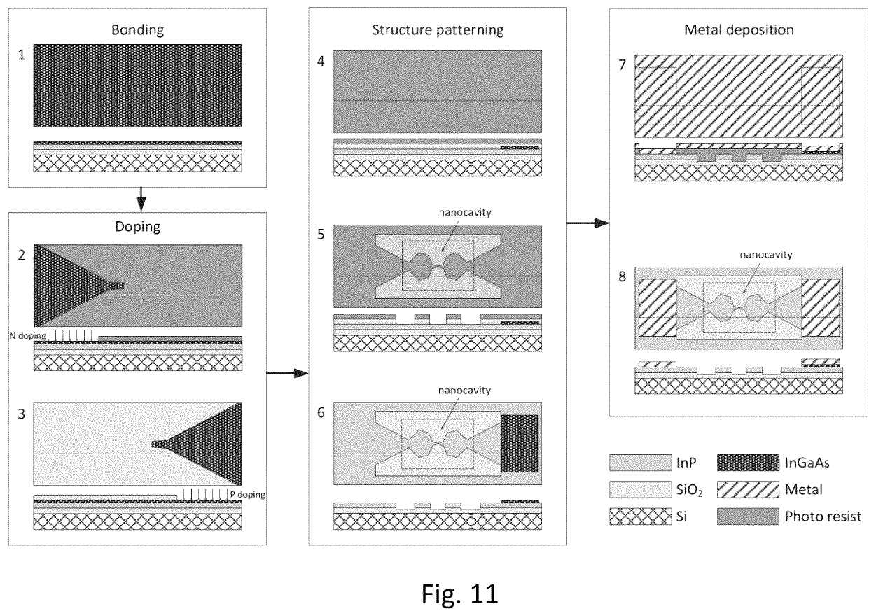

FIG. 11 illustrates a manufacturing process of a nanocavity for a laser.

Generally, standard manufacturing processes, such as those used for macroscopic lasers, as described in [T. Komljenovic et al., PROCEEDINGS OF THE IEEE, 106.12 (2018): 2246-2257], which is hereby incorporated by reference in its entirety, or for photonic crystal nanolasers such as described in [E. Dimopoulos et al., Laser & Photonics Reviews, 16.11 (2022): 2200109], which is hereby incorporated by reference in its entirety, can be employed. The present example is based on the above-referenced manufacturing process for a photonic crystal nanolaser.

The whole process consists of four major steps with approximately eight sub-steps (1-8): wafer bonding, doping, structure patterning, and metal deposition. Each sub-step provides a top view (upper panel) and a cross-sectional view (bottom panel) corresponding to the short dashed line indicated in the top view. FIG. 11 illustrates each of the major steps in rectangular boxes, and within these rectangular boxes, the sub-steps are illustrated with reference numerals 1-8.

In the first major step (bonding), the III-V InP wafer containing layers of quantum wells or quantum dots (not shown here) is flip-bonded on an SOI wafer (SiO₂ on Si). In the second major step (doping), two consecutive photolithography, aligned with each other, are carried out to open windows of tapered shape to allow n- and p-ion implantation into the InP wafer. In the third step (structure patterning), a SiO₂ or SiN hard-mask layer is deposited, followed by a photoresist spin-coated on top, and an e-beam/photolithography is used for aligning and exposing nanocavity patterns. These patterns are then transferred to the InP layer by a two-step dry etching process. In the fourth major step (metal deposition), the device fabrication is completed by depositing the metal pads on the n- and p-doped regions using the standard lift-off method. More details can be found in the publication [E. Dimopoulos, et al., Laser & Photonics Reviews, 16.11 (2022): 2200109].

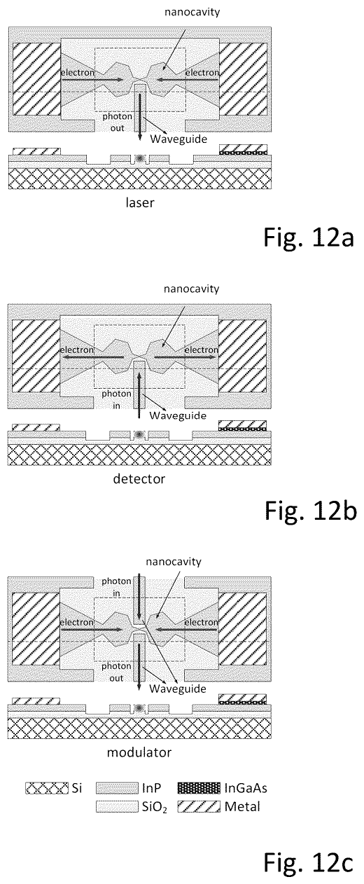

FIGS. 12a-c illustrate various exemplary optical systems comprising a nanocavity having a nanostructure. Each subfigure is illustrated in style similar to the style used in FIG. 11, with individual top panels providing top views and lower panels providing cross-sectional views corresponding to the horizontal dashed lines indicated in the top panels.

FIG. 12a illustrates a laser system comprising a nanocavity, FIG. 12b illustrates a detector comprising a nanocavity, and FIG. 12c illustrates a modulator consisting of a nanocavity. Such nanoscale devices can, for example, be used for chip-scale computing and communication. As an example, such a device is integrated with an electronic transistor through metal contacts such that electrons are firstly used for logic computation by the transistor, followed by the conversion of energy into photons using the nanocavity so that information is transmitted optically, thereby reducing propagation loss. After transmission, photons and their energy can be converted back into electrical energy, such that further operation or storage of information can be performed. In each illustration, electron communication is illustrated by horizontally aligned arrows, and photon communication is illustrated by vertically aligned arrows drawn on top of waveguides.

Generally, each illustrated application uses one or two waveguides optically coupled to the eigenmode by placement within the near-field evanescent tail of the eigenmode.

For applications such as lasers and photodetectors, active materials such as layers of InGaAs/InGaAsP quantum wells or quantum dots are embedded within the InP layer. As for the modulator (FIG. 12c), it can be either active (just like the laser and photodetector) or passive (no active materials embedded).

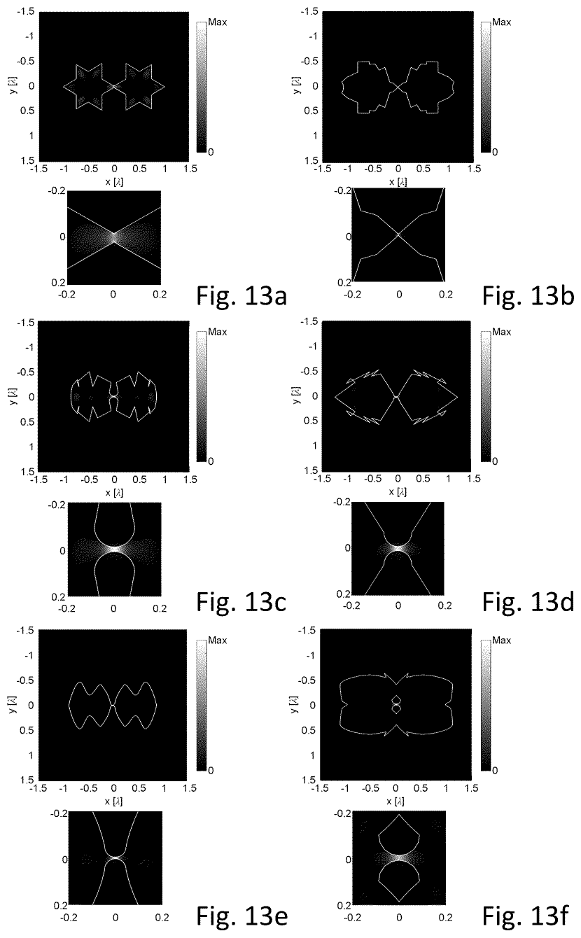

FIGS. 13a-f illustrate the electric field of an eigenmode in further exemplary nanocavities. These are generally illustrated in style similar to the style used in FIGS. 4a-f, with each subfigure providing a heat map of the electric field |E| normalized with respect to a peak value, and the bottom zoomed-in view of the central nanostructure. The coordinates are scaled with respect to the resonant wavelength (in vacuum) of the BIC eigenmode for the respective nanocavity.

The respective nanocavities of the subfigures have mode volumes V and Q factors as follows. FIG. 13a: Q=3855, V=0.9 (W/n)³, FIG. 13b: Q=6246, V=0.5 (λ/n)³, FIG. 13c: Q=2001, V=0.6 (λ/n)³, FIG. 13d: Q=5078, V=0.8 (λ/n)³, FIG. 13e: Q=2000, V=0.24 (λ/n)³, FIG. 13f: Q=15000, V=0.46 (λ/n)³.

Note that the nanocavity illustrated in FIG. 13f provides an example of two resonator segment plates which are not only connected through a nanostructure arranged between and coupling the two resonator segment plates, but also connected by additional portions of the resonator segment plate contacting each other.

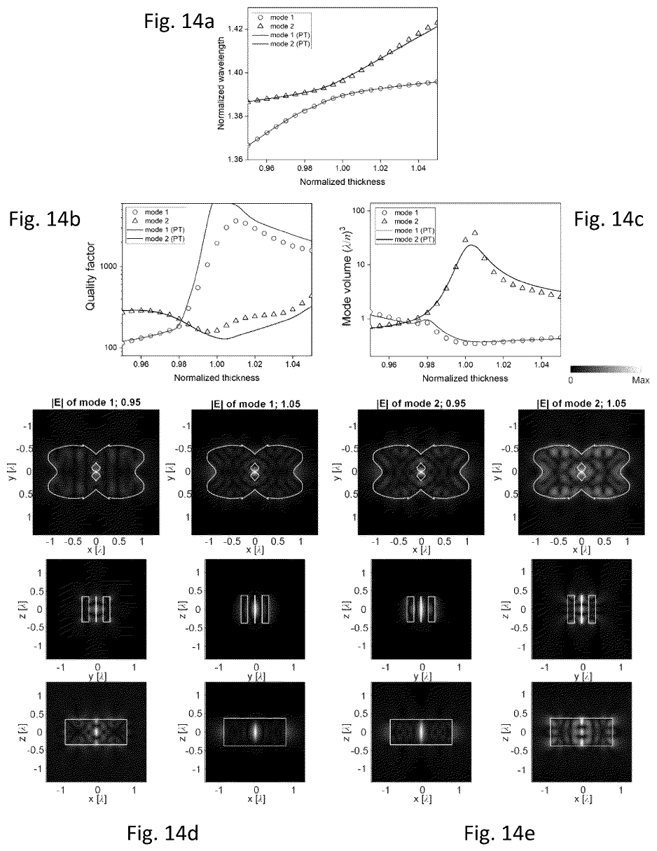

FIGS. 14a-e illustrate evolution of various parameters for varying thickness of an exemplary nanocavity, thereby highlighting the presence of a bound state in the continuum.

In FIG. 14a illustrates the resonant wavelength, FIG. 14b illustrates the quality factors Q, and FIG. 14c illustrates the mode volume. The circles indicate ‘mode 1’ and the triangles indicate ‘mode 2’. These modes are illustrated in FIGS. 14d-e, which illustrate the normalized electrical field distributions at normalized thicknesses of 0.95 (left) and 1.05 (right). The thickness is normalized relative to a point close to where the thickness where the Q-factor of mode 1 is maximized. This mode represents the bound state in the continuum. White lines in the sub-figures indicate boundaries of the nanocavity. The field distributions are illustrated in three orientations, with the top array illustrating the mode filed distributions in the x-y plane, the middle arrays in the y-z plane at x=0, and the bottom arrays in the x-z plane at y=0. The coordinates are normalized by the wavelength of the corresponding eigenmode.

The field patterns depicted in FIGS. 4(d) and 4(e) reveal that the BIC arises from the interaction between two distinct modes: a laterally oscillating mode (mode A, oriented along the x-y plane), resembling a TE₃₁ mode, and a vertically oscillating mode (mode B, oriented along the z-axis), akin to a TE₁₃ mode. Here, we classify the modes as TEₘₖ, where m denotes the number of anti-nodes in the |E| component of the mode fields along the y-axis, and k represents the number of anti-nodes of the mode fields in the z-direction. The patterns illustrated for the different modes indicate the presence of a mode crossing.

Analyses of nanocavities shaped by two resonator segment plates provide more generally that in some embodiments, high-Q BIC modes are composed of a TE(m, k) mode interacting with either a TE(m−2, k+2) mode or TE(m+2, k−2) mode. Considering the nanocavities illustrated in FIGS. 13a-f, one mode can be a laterally oscillating mode oriented along the x-y plane (i.e., the plane of the illustration and the plane of the bottom and top surfaces of the nanocavity), and the other mode can be a vertically oscillating mode oriented along the z-axis (i.e., height direction, perpendicular to the plane of the illustration and to the bottom and top surfaces of the nanocavity). As an example, a BIC mode is composed of a (laterally oscillating) TE(m=3, k=1) mode and a (vertically oscillating) TE(m=1, k=3) mode.

FIGS. 14(a) and 14(b), further illustrates a comparison numerically obtained values of parameters with semi-analytical values obtained by a quasi-normal perturbation theory. The process begins by computing the eigenmodes away from the mode anti-crossing/crossing point—for instance, at h=0.97—where mode interaction is negligible. These eigenmodes and their complex resonant frequencies then serve as a basis for predicting the resonant wavelengths and Q factors of the eigenmodes at other thickness values using quasi-normal mode perturbation theory. The results in FIG. 4 show a good agreement between perturbation theory predictions and full numerical simulations. Applying the perturbation theory at h=0.99 (i.e., near h=1), a Hamiltonian with significant off-diagonal and imaginary parts of the diagonal terms is obtained, which indicates a significant coupling strength and interference effects. Such effects lead to a pronounced alteration in the decay rates and a substantial improvement in the Q-factor for mode 1, thus establishing that the nanocavity can host a bound state in the continuum.

In FIG. 14(c), the mode volume is calculated using a modified version using the center of the nanocavity as a reference point since for mode 2, the field is not always entirely centralized.

Various versions and elements of the invention have been exemplified for the purpose of clarification rather than limitation. Well-known details of methods and systems have been omitted not to obscure the content of the disclosure with redundancy. Various elements and features of the invention and this disclosure may be combined in any way possible within the scope of the claims.

### LIST OF FIGURE REFERENCES

1 optical system
2 nanocavity
3 nanostructure
4 eigenmode
5 resonator segment plate
6 vertex coordinate
7 first medium
8 second medium
9 nanocavity thickness
10 average radius
11 lower radius boundary
12 upper radius boundary
13 center of mass
14 plane of mirror symmetry
15 longitudinal direction
16 transversal direction
17 transverse width
18 interface
19 scale bar
100-115 optimization steps
116 preparation phase
117 optimization phase
118 first optimization method
119 second optimization method
120 third optimization method

1.-15. (canceled)

16. An optical system comprising:
a nanocavity having at least one nanostructure shaped to provide sub-wavelength confinement of an electromagnetic optical field, the nanocavity being shaped and formed to host a bound state in the continuum to provide spatial concentration and temporal storage of the electromagnetic optical field at the at least one nanostructure via an eigenmode of the electromagnetic optical field in the nanocavity.

17. The optical system according to claim 16, wherein the nanocavity is formed by a first medium having a peripheral interface with a second medium,
wherein a refractive index associated with the electromagnetic optical field is greater in the first medium than in the second medium.

18. The optical system according to claim 16, wherein the nanocavity has a planar bottom surface, and a planar top surface parallel to the bottom surface.

19. The optical system according to claim 16, wherein each of the at least one nanostructure comprises a slanted channel of the first medium having an interface with the second medium,
wherein the slanted channel has a transverse width that gradually increases away from a center point of the slanted channel.

20. The optical system according to claim 19, wherein the slanted channel has a transverse width smaller than a wavelength of the electromagnetic optical field in the first medium by at least a factor of 4, for example at least a factor of 40, such as at least a factor of 400.

21. The optical system according to claim 16, wherein the nanocavity is shaped as a circular disc.

22. The optical system according to claim 16, wherein the nanocavity is shaped by at least two resonator segment plates which are optically coupled via the at least one nanostructure arranged between the at least two resonator segment plates.

23. The optical system according to claim 22, wherein each of the at least two resonator segment plates is associated with an outer perimeter,
wherein the outer perimeter of each of the at least two resonator segment plates has a dented shape to provide the bound state in the continuum.

24. The optical system according to claim 23, wherein each of the at least two resonator segment plates is associated with a center of mass and an average radius of the outer perimeter evaluated from the center of mass,
wherein the average radius is between 1.0 and 2.0 in units of wavelength of the electromagnetic optical field in the first medium, for example between 1.2 and 1.8, such as between 1.4 and 1.6.

25. The optical system according to claim 23, wherein each of the at least two resonator segment plates is associated with a center of mass and an average radius of the outer perimeter evaluated from the center of mass,
wherein a ratio of:
a distance between the at least two resonator segment plates evaluated from the center of mass of each of at least the two resonator segment plates; and
the average radius is from 1.4 to 3.5, for example from 1.6 to 3.3, such as from 1.8 to 3.0.

26. The optical system according to claim 23, wherein each of the at least two resonator segment plates is associated with:
a center of mass:
an average radius of the outer perimeter evaluated from the center of mass; and
a lower radius boundary of the outer perimeter evaluated from the center of mass;
wherein a ratio of the lower radius boundary and the average radius is from 0.4 to 0.9, for example from 0.5 to 0.8.

27. The optical system according to claim 26, wherein each of the at least two resonator segment plates is further associated with an upper radius boundary of the outer perimeter evaluated from the center of mass,
wherein a ratio of the upper radium boundary and the average radius is from 1.1 to 1.6, for example from 1.2 to 1.5.

28. The optical system according to claim 16, wherein the optical system further comprises a gain medium.

29. The optical system according to claim 28, wherein the optical system further comprises a pumping source for transferring energy to the gain medium to thereby establish a laser system in which the nanocavity constitutes a laser cavity.

30. A method for processing an electromagnetic optical field, the method comprising the steps of:
shaping and forming a nanocavity such that the nanocavity hosts a bound state in the continuum of the electromagnetic optical field;
providing the nanocavity with at least one nanostructure shaped to provide sub-wavelength confinement of the electromagnetic optical field; and
supplying the electromagnetic optical field to the nanocavity such that the electromagnetic optical field is spatially concentrated and temporarily stored at the at least one nanostructure via an eigenmode of the electromagnetic optical field in the nanocavity.
